(19) United States
(12) Patent Application Publication
(10) Pub. No.: US 2012/0056985 A1
(43) Pub. Date: Mar. 8, 2012

(54) DIGITAL BROADCAST TRANSMITTER AND DIGITAL BROADCAST RECEIVER FOR 3D BROADCASTING, AND METHODS FOR PROCESSING STREAM THEREOF

(75) Inventors: Hae-joo JEONG, Seoul (KR); Chan-sub PARK, Incheon (KR); Kum-ran JI, Suwon-si (KR)

(73) Assignee: SAMSUNG ELECTRONICS CO., LTD., Suwon-si (KR)

(21) Appl. No.: 13/226,666

(22) Filed: Sep. 7, 2011

(30) Foreign Application Priority Data
Sep. 7, 2010 (KR) 10-2010-0087602

(51) Int. Cl. H04N 13/00

(52) U.S. Cl. 348/43; 348/E13.002

(57) ABSTRACT

A digital broadcast transmitter and a digital broadcast receiver for 3-dimensional (3D) broadcasting, and methods for processing a steam thereof. The digital broadcast transmitter includes: a stream processor which processes first and second data parts of an input signal differently from each other, wherein the first data part is to constitute a 2-dimensional (2D) image, and the second data part is to constitute a 3D image; and a transmitter which transmits a transport stream (TR) including the first and second data parts processed by the stream processor.

### CROSS-REFERENCE TO RELATED APPLICATION

This application claims priority from Korean Patent Application No. 10-2010-0087602, filed on Sep. 7, 2010, in the Korean Intellectual Property Office, the disclosure of which is incorporated herein by reference in its entirety.

### BACKGROUND

1. Field

Apparatuses and methods consistent with exemplary embodiments relate to a digital broadcast transmitter and a digital broadcast receiver for 3-dimensional (3D) broadcasting, and methods for processing a stream thereof, and more particularly, to a digital broadcast transmitter and a digital broadcast receiver which separately process data for a 2-dimensional (2D) image and data for a 3D image, and transmit and receive the data, and methods for processing a stream thereof.

2. Description of the Related Art

With the distribution of a digital broadcast, various types of electronic devices support digital broadcasting services. In particular, besides a device, such as a digital broadcasting television (TV), a set-top box, or the like, which is installed in a home, a personal portable device, e.g., a cellular phone, a navigation system, a personal digital assistant (PDA), an Moving Picture Experts Group (MPEG) Audio Layer-3 (MP3) player, also supports a digital broadcasting service.

Efforts to support a 3D broadcasting service have been made so that viewers view 3D images in not only 3D-only theaters but also in homes. A user can possess a display apparatus, which has a function of displaying a 3D image, in order to view 3D broadcasting.

A 3D display apparatus is classified into several types of display apparatuses according to a driving method thereof. For example, according to shutter glass type 3D technology, a display apparatus alternately displays left and right eye images, and 3D glasses worn by a user alternately open and/or close left and right glasses at display timings of the left and right eye images so that the user feels a 3D viewing effect.

In order to support such 3D broadcasting, a digital broadcast transmitter may need to transmit data for a 2D image and data for a 3D image together.

Accordingly, technology for further efficiently transmitting data for a 2D image and data for a 3D image is required.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a digital broadcast transmitter and a digital broadcast receiver which separately process, transmit and receive data for a 2-dimensional (2D) image and data for a 3-dimensional (3D) image to promote data transmission and reception efficiency, and methods for processing a stream thereof.

According to an aspect of an exemplary embodiment, there is provided a digital broadcast transmitter. The digital broadcast transmitter may include: a stream processor which processes first and second data parts of an input signal differently from each other; and a transmitter which transmits a transport stream (TS) comprising the first and second data parts processed by the stream processor, wherein the first data part is to constitute a 2-dimensional (2D) image, and the second data part is to constitute a 3-dimensional image (3D) image.

The stream processor may include: a first error correction coder which performs first error correction coding with respect to the first data part; and a second error correction coder which performs second error correction coding with respect to the second data part.

The stream processor may further include: a first modulator which modulates data output from the first error correction coder using a first modulation method; and a second modulator which modulates data output from the second error correction coder using a second modulation method.

The stream processor may further include: a first modulator which modulates the first data part using a first modulation method; and a second modulator which modulates the second data part using a second modulation method.

The stream processor may include: a group formatter which arranges one of the first and second data parts in a first part which will be arranged in a body area of the TS and the other one of the first and second data parts in a second part which will be arranged in a head/tail area of the TS; a multiplexer which constitutes the TS including the first and second data parts; and an interleaver which interleaves the TS to arrange the first part in the body area and the second part in the head/tail area.

The stream processor may perform at least one of different error correction coding methods and different modulation methods with respect to each of the first and second data parts.

The digital broadcast transmitter may further include a separator which receives the input signal, separates the first and second data parts from the input signal, and provides the first and second data parts to the stream processor.

The digital broadcast transmitter may further include a plurality of separators which receive a plurality of input signals, separate first and second data parts from each of the input signals, sort out the first data parts and the second data parts, and provide the sorted first and second data parts to the stream processor.

According to an aspect of another exemplary embodiment, there is provided a method for processing a stream in a digital broadcast transmitter. The method may include: providing a first data part which is to constitute a 2-dimensional (2D) image and a second data part which is to constitute a 3-dimensional (3D) image; processing the first and second data parts differently from each other; and transmitting a TS including the processed first and second data parts.

The processing the first and second data parts differently from each other may include: performing first error correction coding with respect to the first data part; and performing second error correction coding with respect to the second data part.

The processing the first and second data parts differently from each other may further include: modulating data on which the first error correction coding has been performed, using a first modulation method; and modulating data on which the second error correction coding has been performed, using a second modulation method.

The processing the first and second data parts differently from each other may include: modulating the first data part using a first modulation method; and modulating the second data part using a second modulation method.

The processing the first and second data parts differently from each other may include arranging one of the first and second data parts in a first part which will be arranged in a body area of the TS and the other one of the first and second data parts in a second part which will be arranged in a head/tail area of the TS; and

The transmission of the TS may include: multiplexing the first and second data parts to constitute the TS; and interleaving the TS to arrange the first part in the body area of the TS and the second part in the head/tail area of the TS.

The processing the first and second data parts differently from each other may further include performing at least one of different error correction coding methods and different modulation methods with respect to each of the first and second data parts.

The method may further include separating the first and second data parts from an input signal and providing the first and second data parts.

The method may further include receiving a plurality of input signals, separating first and second data parts from each of the input signals, sorting out the first data parts and the second data parts, and providing the first and second data parts to first and second processors, respectively.

According to an aspect of another exemplary embodiment, there is provided a digital broadcast receiver. The digital broadcast receiver may include: a receiver which receives a TS including first and second data parts, wherein the first data part is to constitute a 2D image, and the second data part is to constitute a 3D image; a separator which separates the first and second data parts from the TS; a first processor which processes the first data part; a second processor which processes the second data part; a display unit which displays a 3D image using the first data part processed by the first processor and the second data part processed by the second processor; and a controller which controls the display unit to display a 2D image using the first data part if the second data part cannot be reproduced.

The first and second processors may perform at least one of different error correction decoding methods and different demodulation methods.

The separator may detect one of the first and second data parts from a body area of the TS and the other one of the first and second data parts from a head/tail area of the TS.

The receiver may receive signaling information, and the separator may separate the first and second data parts using the signaling information and respectively provide the first and second data parts to the first and second processors.

According to an aspect of another exemplary embodiment, there is provided a method for processing a stream in a digital broadcast receiver. The method may include: receiving a TS which includes first and second data parts, wherein the first data part is to constitute a 2D image, and the second data part is to constitute a 3D image; separating the first and second data parts from the TS; and processing the first and second data parts using different methods.

The method may further include displaying a 3D image using the processed first and second data parts and displaying a 2D image using the first data part if the second data part cannot be reproduced.

The processing may be to perform at least one of different error correction decoding methods and different demodulation methods with respect to the first and second data parts.

The separation may be to detect one of the first and second data parts from a body area of the TS and the other one of the first and second data parts from a head/tail area of the TS.

The method may further include receiving signaling information.

According to an aspect of another exemplary embodiment, there is provided a digital broadcast transmitter. The digital broadcast transmitter may include: a stream processor which generates an orthogonal frequency division multiplexing (OFDM) signal including a plurality of sub-carriers; and a transmitter which transmits the OFDM signal.

The OFDM signal may include at least one first layer including a first data part for constituting a 2D image and at least one second layer comprising a second data part for constituting a 3D image. At least one of a modulation method and a coding rate may be applied to the at least one first layer differently from a modulation method and a coding rate applied to the at least one second layer.

According to an aspect of another exemplary embodiment, there is provided a digital broadcast receiver. The digital broadcast receiver may include: a receiver which receives an OFDM signal including a plurality of sub-carriers; and a demodulator which demodulates the OFDM signal.

The OFDM signal may include at least one first layer including a first data part for constituting a 2D image and at least one second layer including a second data part for constituting a 3D image. The at least one first layer is processed by a different modulation method and coding rate from that of the at least one second layer.

As described above, according to the exemplary embodiments, data parts for a 2D image and a 3D image can be further efficiently transmitted and received.

Additional aspects and advantages of the exemplary embodiments will be set forth in the detailed description, will be obvious from the detailed description, or may be learned by practicing the exemplary embodiments.

### BRIEF DESCRIPTION OF THE DRAWINGS

The above and/or other aspects will be more apparent by describing in detail exemplary embodiments, with reference to the accompanying drawings, in which:

FIG. 1 is a block diagram illustrating a structure of a digital broadcast transmitter according to an exemplary embodiment;

FIGS. 2 through 5 are block diagrams illustrating detailed structures and operations of digital broadcast transmitters according to exemplary embodiments;

FIG. 6 is a block diagram illustrating a structure of a digital broadcast transmitter according to another exemplary embodiment;

FIG. 7 is a block diagram illustrating a format of a stream processed by the digital broadcast transmitter of FIG. 6, according to an exemplary embodiment;

FIG. 8 is a flowchart illustrating methods for processing a stream in digital broadcast transmitters according to various exemplary embodiments;

FIGS. 9 and 10 are block diagrams illustrating structures and operations of digital broadcast receivers according to exemplary embodiments; and

FIG. 11 is a flowchart illustrating methods for processing a stream in digital broadcast receivers according to various exemplary embodiments.

### DETAILED DESCRIPTION OF EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that exemplary embodiments can be carried out without those specifically defined matters. Also, functions or elements known in the related art are not described in detail since they would obscure exemplary embodiments with unnecessary detail.

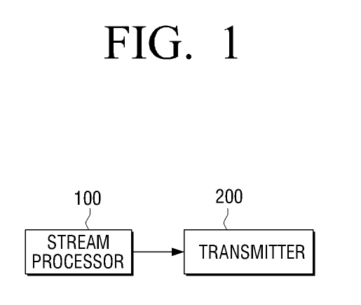

FIG. 1 is a block diagram illustrating a structure of a digital broadcast transmitter according to an exemplary embodiment. Referring to FIG. 1, the digital broadcast transmitter includes a stream processor 100 and a transmitter 200.

The stream processor 100 refers to a construction which differently processes a first data part which is to constitute a 2-dimensional (2D) image and a second data part which is to constitute a 3-dimensional (3D) image.

The first data part which is to constitute the 2D image refers to data which is used by a receiver to display the 2D image. The second data part which is to constitute the 3D image refers to data which is used along with the first data part by the receiver to display the 3D image.

For example, the 3D image may be displayed according to a method of alternately displaying left and right eye images at the predetermined number of times. Here, the left and right eye images refer to images which are obtained by capturing a subject at different capturing angles or in different capturing directions. If a subject is captured at different angles or in different directions in consideration of a distance between left and right eyes of a user, and then a display apparatus alternately displays the captured images of the subject, the user obtains a 3D viewing effect. Here, the left or right eye image may be used to realize a 2D image. Accordingly, the first data part may be one of left and right eye images, and the second data part may be the other one of the left and right eye images.

As another example, the first data part may be 2D image data, and the second data part may be data on depth information which is to give a depth to a 2D image in order to process the 2D image as a 3D image.

As a further example, the first data part may be 2D image data, and the second data part may be additional information which is to alternately output the second data part along with the first data part through a control of a display position, angle, or direction of an image of the first data part so that the first and second data parts are recognized as a 3D image. In other words, the second data part may be data which is obtained by changing a display position, angle, or direction of an object according to the first data part.

The stream processor 100 processes the first and second data parts using different methods. The different methods may be classified into a processing method which is more robust with respect to an error and a processing method which is relatively less robust with respect to an error. Which one of the first and second data parts will be processed to be more robust with respect to an error depends on broadcasting purposes of a transmitter and a receiver. If the purposes of the transmitter and the receiver are to normally display only a 2D image in a poor 3D image viewing environment, the first data part may be processed to be more robust with respect to an error and then transmitted. If data for a 3D image is to be more definitely transmitted, the second data part may be processed to be more robust with respect to an error and then transmitted.

The transmitter 200 outputs a transport stream (TS) which includes the first and second data parts processed by the stream processor 100.

The digital broadcast transmitter may further include various types of elements in addition to or instead of the elements illustrated in FIG. 1. For example, the digital broadcast transmitter may include at least one encoder, an interleaver, a formatter, a multiplexer, a randomizer, a trellis encoder, a sync multiplexer, a pilot inserter, a modulator, a radio frequency (RF) upconverter, an antenna, etc. These elements may be arranged in the stream processor 100 or the transmitter 200 according to exemplary embodiments. These elements may be generally used in the digital broadcast transmitter, and thus detailed descriptions of arrangement orders, functions, or operations of these elements will be omitted. Also, besides the above-described elements, elements well known in the art to which the present inventive concept pertains may be added, and some of the elements may be omitted if necessary.

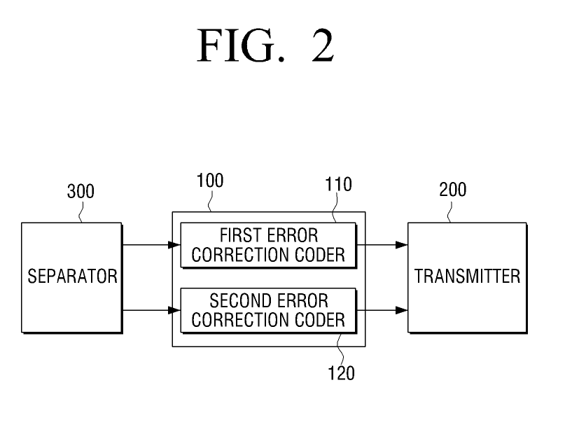

FIG. 2 is a block diagram illustrating a detailed structure of a digital broadcast transmitter according to an exemplary embodiment.

Referring to FIG. 2, the digital broadcast transmitter includes a stream processor 100, a transmitter 200, and a separator 300. The stream processor 100 includes a first error correction coder 110 and a second error correction coder 120.

The separator 300 separates a first data part for a 2D image and a second data part for a 3D image from an input signal and respectively provides the first and second data parts to the first and second error correction coders 110 and 120.

If the first and second data parts respectively correspond to left and right eye images as described above, the separator 300 separates frames which are alternately arranged and provides the frames to the first and second data parts. If the second data part is general data rather than image data, i.e., depth information or information for changing a position, an angle, or a direction, the separator 300 separates an image data frame and the general data from each other.

If the stream processor 100 receives the first and second data parts, respectively, directly from different sources, the separator 300 may not be installed.

The first error correction coder 110 performs first error correction coding with respect to the first data part provided from the separator 300. The second error correction coder 120 performs second error correction coding with respect to the second data part provided from the separator 300.

The first error correction coding and the second error correction coding refer to different types of coding methods which are respectively performed at different coding rates, using different coding methods, or performed a different number of times.

For example, if the first data part is to be processed to be more robust with respect to an error, the first error correction coder 110 may perform error correction coding at a coding rate of ½, and the second error correction coder 120 may perform error correction coding at a coding rate of ¼.

The first and second error correction coder 110 and 120 may respectively process the first and second data parts using completely different coding methods, for example but not limited to block coding, convolution coding, or the like. Also, turbo coding may be applied. The first and second error correction coders 110 and 120 are designed to apply appropriate coding methods in consideration of the importance or applicability of the first and second data parts. For example, if the first data part is to be processed to be more robust with respect to an error, the first error correction coder 110 may perform turbo coding, and the second error correction coder 120 may perform block coding. If the first error correction coder 110 performs turbo coding, the first error correction coder 110 includes a plurality of constituent coders, an interleaver which connects the constituent coders in parallel, and the like. Error correction coding has been well known, and thus illustrations and descriptions of detailed coding methods will be omitted.

The number of times of error correction coding operations are performed by one of the first and second error correction coders 110 and 120 varies according to the importance or applicability of the data. In other words, if processing is to be performed to be more robust with respect to an error, the same or different types of error correction coding processing are additionally performed.

A stream which has been processed by the stream processor 100 is transmitted by the transmitter 200. Data which have been respectively processed by the first and second error correction coders 110 and 120 are multiplied by a multiplexer installed in the stream processor 100 or the transmitter 200 to constitute one stream. The transmitter 200 may perform Reed-Solomon (RS) encoding, interleaving, trellis encoding, sync inserting, modulating, or the like with respect to the stream and then transmit the stream. The transmitter 200 may include various types of elements such as a multiplexer, an RS encoder, an interleaver, a trellis encoder, a sync multiplexer, a modulator, an antenna, etc. These elements may be variously combined, added, or omitted according to various exemplary embodiments. For example, elements such as a randomizer, an RS re-encoder, a packet buffer, an RF upconverter, and the like may be added.

According to another exemplary embodiment, the stream processor 100 separately processes the first and second data parts using a plurality of modulators.

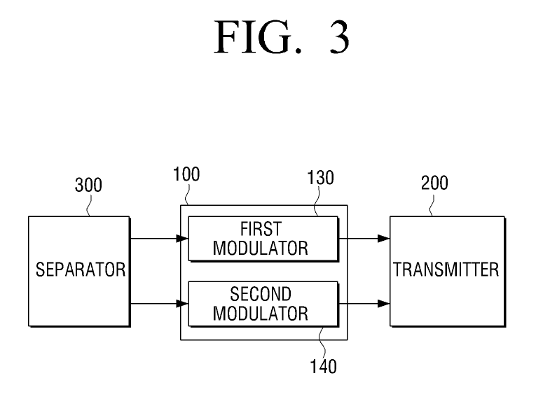

In other words, as shown in FIG. 3, a digital broadcast transmitter includes a separator 300, a stream processor 100, and a transmitter 200. The stream processor 100 includes first and second modulators 130 and 140.

According to the exemplary embodiment of FIG. 3, first and second data parts which have been separated by the separator 300 are respectively provided to the first and second modulators 130 and 140 of the stream processor 100.

The first modulator 130 modulates the first data part using a first modulation method, and the second modulator 140 modulates the second data part using a second modulation method.

The first and second modulators 130 and 140 respectively perform modulations using different modulation methods among binary phase-shift keying (BPSK), quadrature phase-shift keying (QPSK), quadrature amplitude modulation (QAM), vestigial side band (VSB), and orthogonal frequency division multiplexing (OFDM). The OFDM method is combined and used with other modulation methods. The above-mentioned modulation methods are merely examples, and thus other well-known modulation methods may be used.

Like error correction coding, the modulation methods are differently determined according to characteristics of the data parts. For example, the first modulator 130 which modulates the first data part for realizing a 2D image is set to perform the modulation using a modulation method having a higher modulation performance than a modulation method used by the second modulator 140. The opposite case is also possible.

In FIG. 3, as the first and second modulators 130 and 140 are arranged in the stream processor 100, a modulator may be omitted in the transmitter 200. In this case, various types of elements, such as an error correction coder, an interleaver, a trellis encoder, and the like, may be added in front of the first and second modulators 130 and 140 or in front of the separator 300.

According to another exemplary embodiment, the stream processor 100 may respectively process the first and second data parts using different error correction coding methods and different modulation methods.

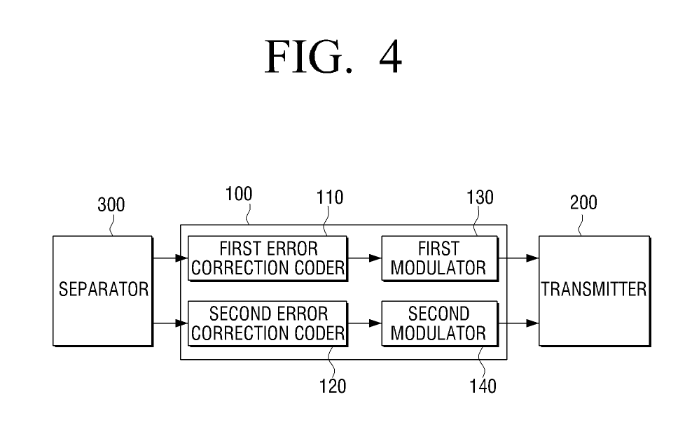

Referring to FIG. 4, a stream processor 100 includes first and second error correction coders 110 and 120 and first and second modulators 130 and 140. Here, the first error correction coder 110 and the first modulator 130 form a first pass, and the second error correction coder 120 and the second modulator 140 form a second pass.

A first data part provided from a separator 300 is processed in the first pass, and a second data part provided from the separator 300 is processed in the second pass.

Detailed illustrations of error correction coding methods and modulation methods have been described with reference to FIGS. 2 and 3 and thus will be omitted herein.

As in the above-described exemplary embodiments, various types of elements may be additionally installed in the exemplary embodiment of FIG. 4. For example, in the exemplary embodiment of FIG. 4, various types of elements, such as an RS encoder, an interleaver, a trellis encoder, a sync multiplexer, and the like, may be additionally arranged between the first error correction coder 110 and the first modulator 130 and between the second error correction coder 120 and the second modulator 140. Also, the first and second data parts which have been respectively processed through the first and second passes are multiplied by the transmitter 200 to constitute a stream, and then the stream is transmitted through the transmitter 200 to the outside.

The above-described additional elements are known through an existing broadcast transmitter, and thus their detailed illustrations and descriptions will be omitted.

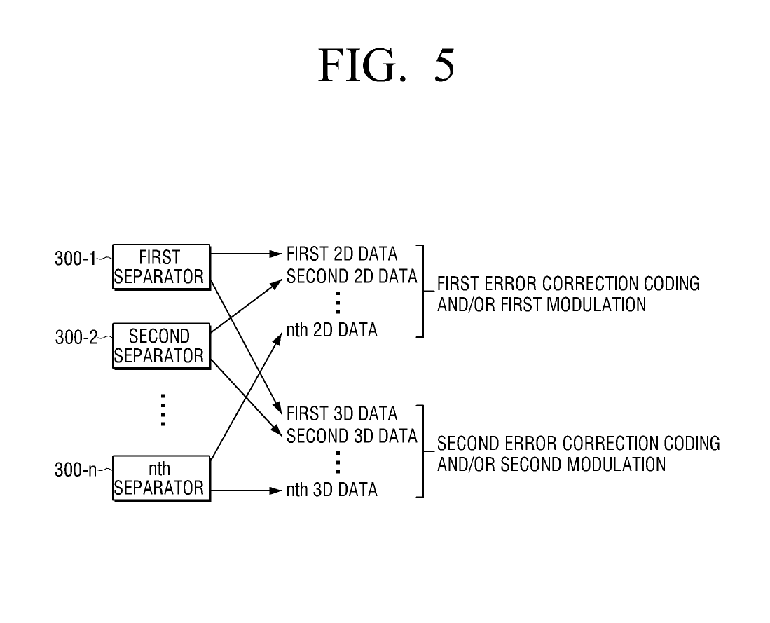

FIG. 5 is a block diagram illustrating a structure of a digital broadcast transmitter according to another exemplary embodiment.

Referring to FIG. 5, the digital broadcast transmitter includes a plurality of separators, i.e., first, second, . . . , n^{th} separators 300-1, 300-2, . . . , 300-n. Each of the first, second, . . . , n^{th} separators 300-1, 300-2, . . . , 300-n separates first and second data parts, i.e., 2D data and 3D data, from an input signal provided from a corresponding source, sorts out the first and second data parts, and transmits the sorted first and second data parts to a next block. In other words, referring to FIGS. 2 through 4, pieces of 2D data are provided to the first error correction coder 110 and/or the first modulator 130, and pieces of 3D data are provided to the second error correction coder 120 and/or the second modulator 140. Therefore, a plurality of pieces of 2D data and a plurality of pieces of 3D data are processed using different methods.

According to another exemplary embodiment, different error correction coding methods and/or modulation methods are applied to the first and second data parts, and the first and second data parts are arranged in different positions on a stream, thereby varying a transmission performance.

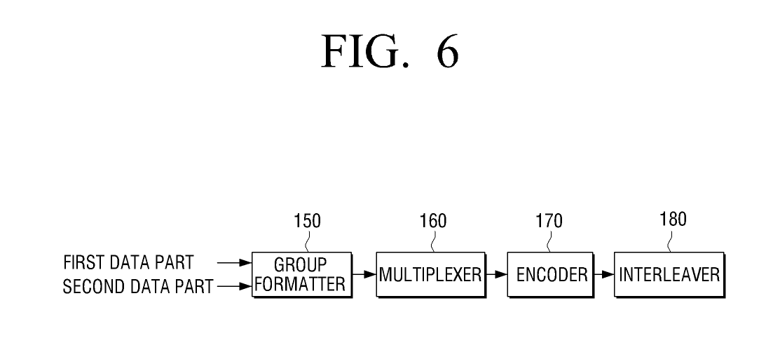

Referring to FIG. 6, a digital broadcast transmitter includes a group formatter 150, a multiplexer 160, an encoder 170, and an interleaver 180. Although not shown in FIG. 6, the group formatter 150, the multiplexer 160, the encoder 170, and the interleaver 180 may be arranged in the stream process 100 of FIG. 1. Various types of elements, such as an error correction coder, a modulator, a trellis encoder, a sync multiplexer, and the like, as described with reference to FIGS. 1 through 5, may be additionally installed in the digital broadcast transmitter of FIG. 6.

The group formatter 150 of FIG. 6 perform formatting to determine a position of at least one of first and second data parts in a TS and arrange data in the determined position.

Stream data which will be transmitted is divided into a plurality of transmission units and then arranged. If the interleaver 180 performs interleaving in this state, positions of pieces of data are re-arranged. In this state, pieces of data existing in a specific transmission unit are classified into a head area, a body area, and a tail area.

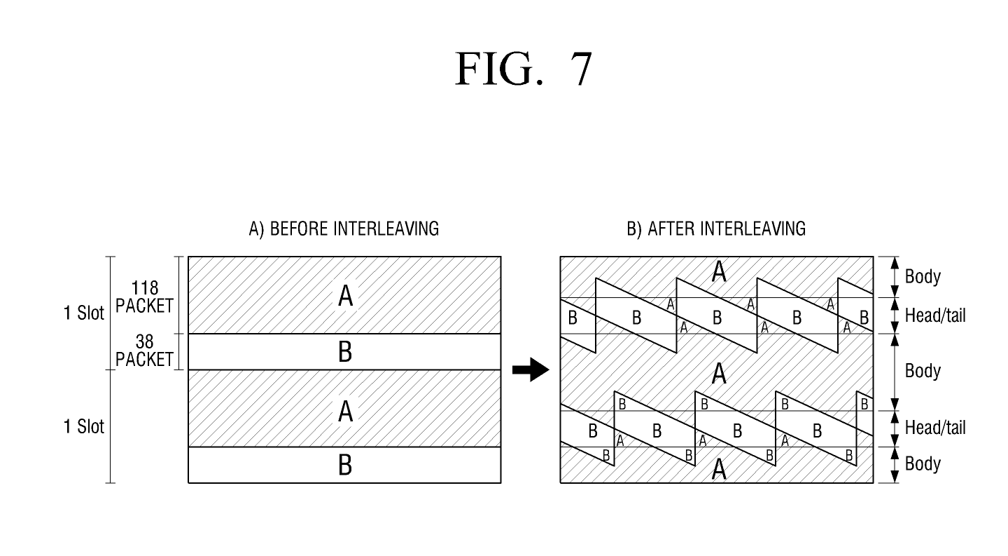

FIG. 7 is a view illustrating changes in a format of a stream before and after interleaving is performed according to an exemplary embodiment.

Referring to FIG. 7, a slot which is a transmission unit of the stream is classified into an area A and an area B in the unit of a plurality of packets. In FIG. 7, the area A includes 118 packets, and the area B includes 38 packets, but the number of packets may be variously changed if necessary or according to exemplary embodiments.

If the interleaver 180 performs interleaving in this state, each of the area A and the area B classified into head areas and tail areas having horn shapes, and body areas. In FIG. 7, the body areas and the head and/or tail areas are classified based on the area A which occupies more portion than the area B. Here, the body areas range from start points of horns of the head areas to start points of horns of the tail areas. However, as shown in 7, the body areas range from the start points to points which are at predetermined distances from the start points.

If interleaving is performed as described above, stream transmission performances of the head and/or tail areas become relatively lower than those of the body areas.

In other words, if the group formatter 150 inserts a training sequence into the area A in a preset pattern in consideration of interleaving rules, a long training sequence is formed in the body areas after interleaving is performed. Although a training sequence is inserted into the area B in the head and/or tail areas, the area A is mixed among the area B. Therefore, a long training sequence is not formed in the head and/or tail areas. If the long training sequence is included, a receiver performs an equalization, a modulation, or the like using the corresponding long training sequence. Thus, a distortion of a channel is easily compensated for. As a result, the head and/or tail areas which do not include the long training sequence have lower channel distortion compensation abilities than the body areas.

In consideration of these points, the group formatter 150 appropriately arranges one of the first and second data parts, a transmission performance of which is to be improved, to arrange the one data part in a body area after interleaving is performed. The group formatter 150 appropriately arranges the other data part to arrange the other data part in a head and/or tail area after interleaving is performed. Arrangement positions of the first and second data parts may be pre-determined in consideration of interleaving rules. Hereinafter, a stream area which does not go through interleaving and corresponds to a body area after interleaving is performed will be referred to as a first part, and a stream area which does not go through interleaving and corresponds to a head and/or tail area after interleaving is performed will be referred to as a second part.

When the group formatter 150 respectively formats the first and second data parts and provides the formatted first and second parts to the multiplexer 160, the multiplexer 160 multiplexes the first and second data parts to constitute a TS.

The encoder 170 encodes the TS and adds a parity bit to the encoded TS.

The interleaver 180 interleaves the encoded TS to constitute a TS having a format as shown in FIG. 7. As a result, one of the first and second data parts is arranged in a body area, and the other data part is arranged in a head and/or tail area.

The digital broadcast transmitter of FIG. 6 may further include at least one of an error correction coder and a modulator, wherein the error correction coder performs different error correction coding methods with respect to the first and second data parts, and the modulator respectively modulates the first and second data parts using different modulation methods.

An exemplary embodiment to differently determine arrangement positions of first and second data parts and process the first and second data parts using different processing methods may be applied.

A format of a TS as shown in FIG. 7 is specifically described in ATSC-MH standards. Therefore, the digital broadcast transmitter of FIG. 6 may further include elements which are disclosed in ATSC-MH standards. Except for the elements described in FIG. 6, ATSC-MH elements are not related to contents of the present inventive concept for separately processing first and second data parts, and thus their detailed descriptions and illustrations will be omitted.

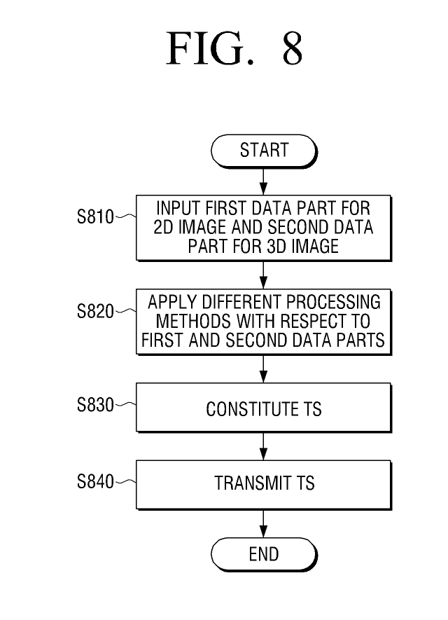

FIG. 8 is a flowchart illustrating a method for processing a stream in a digital broadcast transmitter according to an exemplary embodiment.

Referring to FIG. 8, a first data part for a 2D image and a second data part for a 3D image are input (S810). Different processing methods are respectively performed with respect to the first and second data parts (S820). In more detail, different error correction coding methods or different modulation methods are respectively applied to the first and second data parts. Alternatively, different error correction coding methods and different modulation methods may be applied to the first and second data parts. Positions of the first and second data parts which are arranged in a stream may be set differently to set different transmission performances of the first and second data parts.

Accordingly, a transmission performance of one of the first and second data parts may be relatively improved to prepare for a situation in which both the first and second data parts may not be normally transmitted.

For example, the first data part corresponding to the 2D image may be more reliably provided.

A TS including the first and the second data parts, which are differently processed, is constituted (S830) and is transmitted (S840).

As a result, a receiver may separately process a 2D data part and a 3D data part. A 3D image is reproduced using both the 2D data part, i.e., the first data part, and the 3D data part, i.e., the second data part, in an environment or condition capable of producing a 3D image. In an environment or condition providing less capabilities of producing a 3D image, the 3D data part is calculated using the 2D data part, and the 3D image is reproduced using the calculated 3D data part. In an environment or condition incapable of producing a 3D image, a 2D image may be reproduced using only the 2D data part.

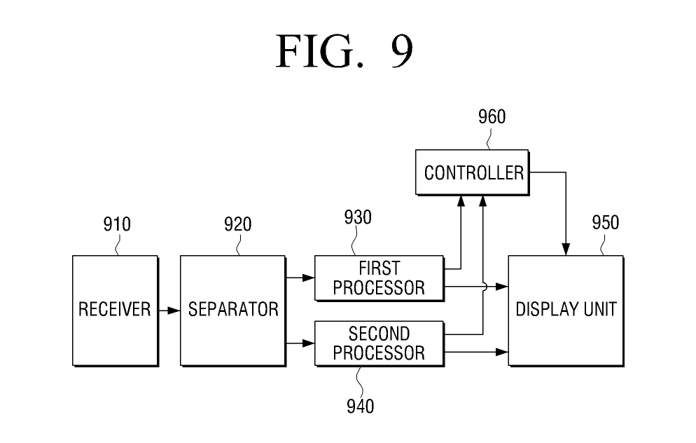

FIG. 9 is a block diagram illustrating a digital broadcast receiver according to an exemplary embodiment. Referring to FIG. 9, the digital broadcast receiver includes a receiver 910, a separator 920, a first processor 930, a second processor 940, a display unit 950, and a controller 960.

The receiver 910 receives a TS from a digital broadcast transmitter.

The separator 920 separates first and second data parts from the TS. In this case, the separator 920 checks arrangement positions of the first and second data parts from a header part of the TS, signaling data which is additionally provided in the TS, or signaling data which is transmitted through an additional transmission channel and separates the first and second data parts from the arrangement positions. Alternatively, if the arrangement positions of the first and second data parts are pre-determined, the separator 920 may separate the first and second data parts from the pre-determined arrangement positions.

The first and second data parts which have been separated by separator 920 are respectively provided to the first and second processors 930 and 940. Here, the first processor 930 may be a first error correction decoder which performs decoding using a decoding method corresponding to a coding method of the first error correction coder 110. Alternatively, the first processor 930 may be a first demodulator which performs a demodulation using a demodulation method corresponding to a modulation method of the first modulator 130. The first processor 930 may include both the first modulator and the first error correction decoder.

The second processor 940 may be at least one of a second error correction decoder and a second demodulator which respectively correspond to the second error correction coder 120 and the second modulator 140. Therefore, separate processing methods may be performed with respect to the first and second data parts.

If the first data part is transmitted with being included in a body area, and the second data part is transmitted with being included in a head/tail area as in the exemplary embodiment of FIG. 6, the first and second processors 930 and 940 respectively process the first and second data parts using the same processing method. In other words, since the first and second data parts have different performances in their transmission processes, different error correction decoding methods and different modulation methods may not be performed.

The controller 960 monitors whether normal processing which produces both first (2D) and second (3D) data parts can be performed in the first and second processors 930 and 940. Therefore, the controller 960 determines whether one of the first and second data parts which is difficult to be normally processed by the first and second processors 930 and 940 exists. For example, the controller 960 checks a signal-to-noise ratio (SNR) of data which have gone through error correction decoding through the first and second processors 930 and 940, and if the SNR is higher than or equal to a threshold value, determines the data as a signal which cannot be normally reproduced to provide a 3D image.

The controller 960 controls the display unit 950 to display a 2D image or a 3D image according to the determination result.

In more detail, if data which has been processed by both the first and second processors 930 and 940 is able to be normally reproduced to provide a 3D image, the controller 960 realizes a 3D image using both the first and second data parts. In other words, the first data part may be a left eye image, and the second data part may be a right eye image. In this case, the controller 960 controls the display unit 950 to alternately display the left and right eye images.

If data output from the second processor 940, which processes a data part which has been processed using a method of relatively lowering a transmission performance, is deteriorated the controller 960 controls the display unit 950 to display a 2D image or a 3D image according to the degree of deterioration of the data. In other words, if the degree of deterioration is severe, the controller 960 controls the display unit 950 to display only the first data part, i.e., the left eye image, to provide a 2D image. If the deterioration degree is not severe, and thus the right eye image is generated from the left eye image, the controller 960 controls the display unit 950 to display a 3D image using the first data part. In other words, if information on capturing angle, direction, position, and the like of an image is able to be recovered in the second data part, the right eye image is generated from the first data part, i.e., the left eye image, using the information.

In the above-described exemplary embodiments, a first data part corresponds to a left eye image, and a second data part corresponds to a right eye image. However, the exemplary embodiments are not limited thereto, and thus the opposite case is possible. Also, the first data part does not need to be transmitted using a method or to a position which has a higher transmission performance than a method and a position of the second data part. Therefore, the opposite case is possible according to various exemplary embodiments.

When a 3D image is to be realized, the display unit 950 alternately repeatedly displays the left and right eye images which have been generated using the first and second data parts. In this case, in a system which operates with 3D glasses, an exemplary digital broadcast receiver may further include a construction which generates a sync signal for synchronizing display timings of left and right eye images with a shutter glass driving timing of the 3D glasses.

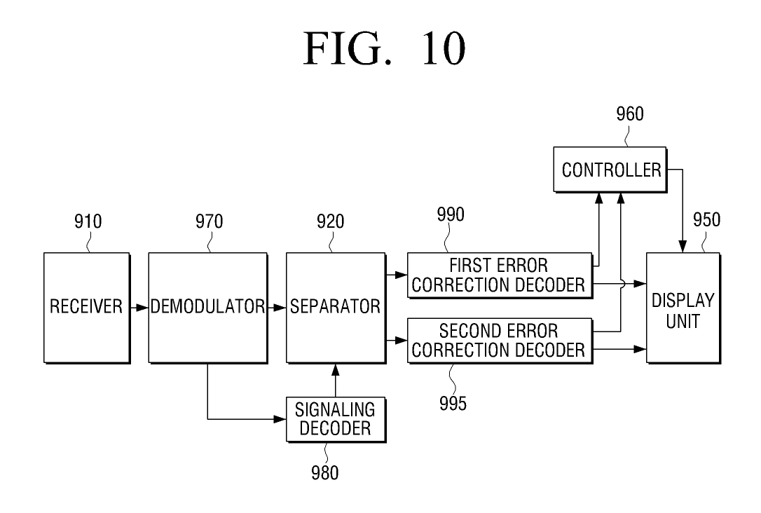

FIG. 10 is a block diagram illustrating a structure of a digital broadcast receiver according to another exemplary embodiment. Referring to FIG. 10, the digital broadcast receiver includes a receiver 910, a demodulator 970, a separator 920, first and second error correction decoders 990 and 995, a controller 960, a display unit 950, and a signaling decoder 980.

Differently from the exemplary embodiment of FIG. 9, the exemplary embodiment of FIG. 10 exemplifies that one demodulator demodulates a stream received from the receiver 910 using a common demodulation method. The demodulated stream is provided to the separator 920.

The signaling decoder 980 decodes signaling information, which is transmitted along with or separately from a TS, to provide information on arrangement positions or processing methods of first and second data parts to the separator 920.

The separator 920 detects the first and second data parts from the TS according to the information provided from the signaling decoder 980 and respectively provides the first and second data parts to the first and second error correction decoders 990 and 995.

The controller 960 controls the display unit 950 to display a 2D image or a 3D image according to a state of data which is processed by the first and second error correction decoders 990 and 995. Descriptions of this are the same as those of FIG. 9 and thus will be omitted.

As described above, the structure of the digital broadcast receiver may also be combined and realized in various forms. In FIGS. 9 and 10, elements, such as an equalizer, a trellis decoder, a deinterleaver, a decoder, and the like, may be added in the various numbers and various positions according to various exemplary embodiments.

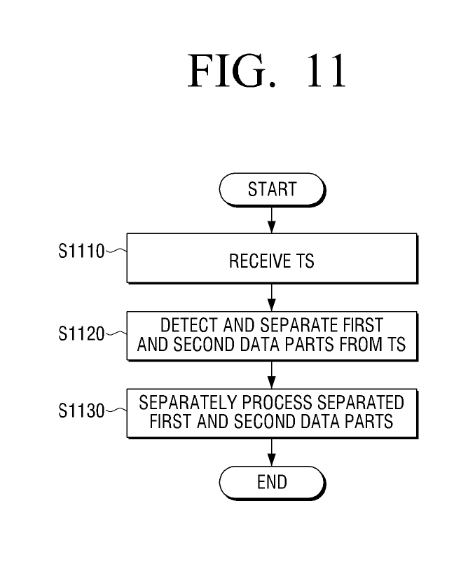

FIG. 11 is a flowchart illustrating a method for processing a stream in a digital broadcast receiver according to an exemplary embodiment.

Referring to FIG. 11, a TS is received (S1110). First and second data parts are separated from the TS (S1120). The first and second data parts are separately processed using corresponding methods (S1130) to reproduce data. In more detail, different error correction decoding methods and different demodulation methods may be applied to process the first and second data parts. Also, the first and second data parts are detected from a body area and a head and/or tail area of the TS (S1120).

Therefore, a 2D image or a 3D image is provided according to states of the first and second data parts.

In the above-described exemplary embodiments, the first and second data parts are data parts for providing a 3D image, but the exemplary embodiments are not limited thereto.

In other words, the spirit of the present inventive concept may be applied to any case where when different types of data parts are to be transmitted together, one of the different types of data parts is to be further stably transmitted so that a receiver uses only the one data part.

For example, in the case of picture data reproduced in an electronic frame or the like, image data and audio data may be transmitted together so that music is enjoyed along with a picture. If a state of a channel is degraded in this case, a first data part may be realized as image data, and a second data part may be realized as audio data in order to set a processing method or an arrangement position of the first data part to be more robust with respect to an error, such that only the picture is further stably enjoyed.

The above-described digital broadcast receiver may be realized as a fixed type terminal device, such as a TV, a set-top box, an electronic frame, a PC, or the like, or a portable device such as a cellular phone, a PDA, a notebook PC, an MP3 player, or the like.

Also, the present inventive concept may be applied to broadcast systems which comply with other standards.

For example, in a system which complies with Integrated Services Digital Broadcasting-Terrestrial (ISDB-T) standards, one channel includes 13 segments. The 13 segments are classified into 3 layers according to the number of sub-carriers. Different coding rates and different modulation methods are respectively applied to the 3 layers, and thus reception performances of the 3 layers are different from one another.

Therefore, a first data part for constituting a 2D image may be transmitted using one or more of the 3 layers having the high reception performances, and a second data part for constituting a 3D image may be transmitted using the layer having a relatively poor reception performance.

Accordingly, if a state of a channel is fine (in the case of fixed reception), a receiver receives and detects all of the first and second data parts to realize a 3D image using the first and second data parts. If the state of the channel is degraded and a user wants to output a 3D image, or in the case of an existing TV which cannot output a 3D image, a 2D image may be realized using only the first data part.

If the state of the channel is poor (e.g., in the case of moving reception), the receiver may realize the 2D image using only data of the layer having a high reception performance.

A modulation method of each of the 3 layers may be set to differential quadrature phase-shift keying (DQPSK), QPSK, 16QAM, 64QAM, or the like, and a coding rate of each of the 3 layers may be set to ½, ⅔, ¾, ⅚, ⅞, or the like.

The reception performance of each of the 3 layers may be determined through a combination of a modulation method and a coding rate. If a reception performance of a layer using a QPSK modulation method and a coding rate of ½ is relatively higher than a reception performance of a layer using a 64QAM modulation method and a coding rate of ⅞. Therefore, if the two layers exist, the first data part is transmitted through the layer using the QPSK modulation method and the coding rate of ½, and the second data part is transmitted through the layer using the 64QAM modulation method and the coding rate of ⅞.

A structure of a digital broadcast transmitter which complies with ISDB-T standards may also include a stream processor and a transmitter as shown in FIG. 1.

In this case, the stream processor generates an OFDM signal including a plurality of sub-carriers, and the transmitter transmits the OFDM signal.

The OFDM signal includes at least one first layer including a first data part for constituting a 2D image and a second layer including a second data part for constituting a 3D image. Here, at least one of a modulation method and a coding rate is applied to the at least one first layer differently from a modulation method and a coding rate of the second layer.

Also, the OFDM which has been processed and transmitted using this method is received and processed by a digital broadcast receiver which includes a receiver and a demodulator. The receiver receives the OFDM signal including the plurality of sub-carriers, and the demodulator demodulates the OFDM signal. Therefore, if all of data of the layers are detected and processed, a 3D image is reproduced using the data. If only some of the layers are detected and processed, a 2D image is reproduced.

Detailed structures of the digital broadcast transmitter and the digital broadcast receiver which comply with ISDB-T standards may be referred to in standard documents or the like, and thus their detailed illustrations and descriptions will be omitted.

Also, examples of combinations of modulation methods and coding rates may be equally applied to the above-described other standards.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A digital broadcast transmitter, comprising:
a stream processor which processes first and second data parts of an input signal differently from each other; and
a transmitter which transmits a transport stream (TS) comprising the first and second data parts processed by the stream processor,
wherein the first data part is to constitute a 2-dimensional (2D) image, and
the second data part is to constitute a 3-dimensional image (3D) image.

2. The digital broadcast transmitter as claimed in claim 1, wherein the stream processor comprises:
a first error correction coder which performs first error correction coding with respect to the first data part; and
a second error correction coder which performs second error correction coding with respect to the second data part.

3. The digital broadcast transmitter as claimed in claim 2, wherein the stream processor further comprises:
a first modulator which modulates data output from the first error correction coder using a first modulation method; and
a second modulator which modulates data output from the second error correction coder using a second modulation method.

4. The digital broadcast transmitter as claimed in claim 1, wherein the stream processor comprises:
a first modulator which modulates the first data part using a first modulation method; and
a second modulator which modulates the second data part using a second modulation method.

5. The digital broadcast transmitter as claimed in claim 1, wherein the stream processor comprises:
a group formatter which arranges one of the first and second data parts in a first part which will be arranged in a body area of the TS and the other one of the first and second data parts in a second part which will be arranged in a head/tail area of the TS;
a multiplexer which constitutes the TS comprising the first and second data parts; and
an interleaver which interleaves the TS to arrange the first part in the body area and the second part in the head/tail area.

6. The digital broadcast transmitter as claimed in claim 5, wherein the stream processor performs at least one of different error correction coding methods and different modulation methods with respect to each of the first and second data parts.

7. The digital broadcast transmitter as claimed in claim 1, further comprising a separator which receives the input signal, separates the first and second data parts from the input signal, and provides the first and second data parts to the stream processor.

8. The digital broadcast transmitter as claimed in claim 1, further comprising a plurality of separators which receive a plurality of input signals, separate first and second data parts from each of the input signals, sort out the first data parts and the second data parts, and provide the sorted first and second data parts to the stream processor.

9. A method for processing a stream in a digital broadcast transmitter, the method comprising:
providing a first data part which is to constitute a 2-dimensional (2D) image and a second data part which is to constitute a 3-dimensional (3D) image;
processing the first and second data parts differently from each other; and
transmitting a transport stream (TS) comprising the processed first and second data parts.

10. The method as claimed in claim 9, wherein the processing the first and second data parts differently from each other comprises:
performing first error correction coding with respect to the first data part; and
performing second error correction coding with respect to the second data part.

11. The method as claimed in claim 10, wherein the processing the first and second data parts differently from each other further comprises:
modulating data on which the first error correction coding has been performed, using a first modulation method; and
modulating data on which the second error correction coding has been performed, using a second modulation method.

12. The method as claimed in claim 9, wherein the processing the first and second data parts differently from each other comprises:
modulating the first data part using a first modulation method; and
modulating the second data part using a second modulation method.

13. The method as claimed in claim 9, wherein:
the processing the first and second data parts differently from each other comprises:
arranging one of the first and second data parts in a first part which will be arranged in a body area of the TS and the other one of the first and second data parts in a second part which will be arranged in a head/tail area of the TS; and
the transmission of the TS comprises:
multiplexing the first and second data parts to constitute the TS; and
interleaving the TS to arrange the first part in the body area of the TS and the second part in the head/tail area of the TS.

14. The method as claimed in claim 13, wherein the processing the first and second data parts differently from each other further comprises performing at least one of different error correction coding methods and different modulation methods with respect to each of the first and second data parts.

15. The method as claimed in claim 9, further comprising separating the first and second data parts from an input signal and providing the first and second data parts to first and second processors, respectively.

16. The method as claimed in claim 9, further comprising receiving a plurality of input signals, separating first and second data parts from each of the input signals, sorting out the first data parts and the second data parts, and providing the first and second data parts to first and second processors, respectively.

17. A digital broadcast receiver, comprising:
a receiver which receives a transport stream (TS) comprising first and second data parts, wherein the first data part is to constitute a 2D image, and the second data part is to constitute a 3D image;
a separator which separates the first and second data parts from the TS;
a first processor which processes the first data part;
a second processor which processes the second data part;
a display unit which displays a 3D image using the first data part processed by the first processor and the second data part processed by the second processor; and
a controller which controls the display unit to display a 2D image using the first data part if the second data part cannot be reproduced.

18. The digital broadcast receiver as claimed in claim 17, wherein the first and second processors perform at least one of different error correction decoding methods and different demodulation methods.

19. The digital broadcast receiver as claimed in claim 17, wherein the separator detects one of the first and second data parts from a body area of the TS and the other one of the first and second data parts from a head/tail area of the TS.

20. The digital broadcast receiver as claimed in claim 17, wherein:
the receiver receives signaling information; and
the separator separates the first and second data parts using the signaling information and respectively provides the first and second data parts to the first and second processors.

21. A method for processing a stream in a digital broadcast receiver, the method comprising:
receiving a transport stream (TS) which comprises first and second data parts, wherein the first data part is to constitute a 2D image, and the second data part is to constitute a 3D image;
separating the first and second data parts from the TS; and
processing the first and second data parts using different methods.

22. The method as claimed in claim 21, further comprising displaying a 3D image using the processed first and second data parts and displaying a 2D image using the first data part if the second data part cannot be reproduced.

23. The method as claimed in claim 22, wherein the processing is to perform at least one of different error correction decoding methods and different demodulation methods with respect to the first and second data parts.

24. The method as claimed in claim 22, wherein the separation is to detect one of the first and second data parts from a body area of the TS and the other one of the first and second data parts from a head/tail area of the TS.

25. The method as claimed in claim 22, further comprising receiving signaling information.

26. A digital broadcast transmitter, comprising:
a stream processor which generates an orthogonal frequency division multiplexing (OFDM) signal comprising a plurality of sub-carriers; and
a transmitter which transmits the OFDM signal,
wherein the OFDM signal comprises at least one first layer comprising a first data part for constituting a 2D image and at least one second layer comprising a second data part for constituting a 3D image,
wherein at least one of a modulation method and a coding rate is applied to the at least one first layer differently from a modulation method and a coding rate applied to the at least one second layer.

27. A digital broadcast receiver, comprising:
a receiver which receives an OFDM signal comprising a plurality of sub-carriers; and
a demodulator which demodulates the OFDM signal,
wherein the OFDM signal comprises at least one first layer comprising a first data part for constituting a 2D image and at least one second layer comprising a second data part for constituting a 3D image,
wherein the at least one first layer is processed by a different modulation method and coding rate from that of the at least one second layer.
